(19) United States
(12) Patent Application Publication
(10) Pub. No.: US 2010/0186406 A1
(43) Pub. Date: Jul. 29, 2010

(54) CONTROL DEVICE OF AN INTERNAL COMBUSTION ENGINE

(75) Inventor: Naoya Kaneko, Shizuoka-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Toyota-shi (JP)

(21) Appl. No.: 12/666,134

(22) PCT Filed: Jun. 20, 2008
(86) PCT No.: PCT/IB08/01617

§ 371 Date: Dec. 22, 2009

(30) Foreign Application Priority Data
Jun. 22, 2007 (JP) 2007-165529

(51) Int. Cl. F02D 23/00; F01L 1/34

(52) U.S. Cl. 60/602; 123/90.15

(57) ABSTRACT

An internal combustion engine control device includes: an internal combustion engine in which a cylinder includes a turbo-side exhaust valve that opens and closes an exhaust port that communicates with a turbo-side exhaust passageway that leads to a turbine's inlet opening of a turbosupercharger, and with a bypass-side exhaust valve that opens and closes an exhaust port that communicates with a bypass-side exhaust passageway that bypasses the turbine; a bypass control valve provided on the bypass-side exhaust passageway; an exhaust-side valve-operating device that opens and closes the turbo-side exhaust valve and the bypass-side exhaust valve in accordance with cam profiles that are provided, only one for each of the turbo-side exhaust valve and the bypass-side exhaust valve; and a control portion that controls degree of opening of the bypass control valve according to an operation status of the engine.

### BACKGROUND OF THE INVENTION

1. Field of the Invention

The invention relates to a control device for an internal combustion engine.

2. Description of the Related Art

Generally, a turbosupercharger-equipped engine has a problem of the back pressure sometimes becoming excessively high in a high-speed and high-load operation region and therefore making it difficult to discharge the burned gas from the cylinders, so that the amount of gas remaining in the cylinders tends to be large. If the amount of residual gas in the cylinders becomes large, the combustion rate becomes slow and the in-cylinder temperature becomes high, so that knocking is likely to occur. Then, in order to avoid the knocking, it becomes necessary to perform an ignition timing retardation, which results in degraded fuel economy and reduced engine output. Besides, increases in the amount of residual gas correspondingly reduce the amount of air. Due to these circumstances, it is not easy to increase the output of the turbosupercharger-equipped engine in a high rotation speed operation region.

In order to solve the problem as stated above, Japanese Patent Application Publication No. 10-89106 (JP-A-10-89106), for example, discloses an engine in which each cylinder is provided with a turbo-side exhaust valve that opens and closes an exhaust port that communicates with a turbo-side exhaust passageway that leads to a turbine inlet opening of the turbosupercharger, and with a bypass-side exhaust valve that opens and closes an exhaust port that communicates with a bypass-side exhaust passageway that does not lead to the turbine inlet opening.

The foregoing publication describes that the valve lift characteristics of the turbo-side exhaust valve and the bypass-side exhaust valve may be constant from a low rotation speed region to a high rotation speed region, and also describes that, alternatively, valve lift characteristic variable means may be provided, and that the open-valve periods and the valve lift amounts of the turbo-side exhaust valve and the bypass-side exhaust valve may be substantially the same during a high rotation speed region, but during a low rotation speed region, the open-valve period and the valve lift amount of the turbo-side exhaust valve may be made larger and the open-valve period and the valve lift amount of the bypass-side exhaust valve may be made smaller, compared with during the high rotation speed region (Paragraph 0018 in JP-A-10-89106).

However, in the case where the valve lift characteristics of the turbo-side exhaust valve and the bypass-side exhaust valve are set constant from the low rotation speed region to the high rotation speed region, exhaust gas flows into the bypass-side exhaust passageway during the low rotation speed region in the amount of a certain percentage of the total amount of exhaust gas, and the amount of exhaust gas that flows into the turbine becomes correspondingly less, thus giving rise to a problem of the rising of charging pressure becoming late (the turbo lag becoming large). On the other hand, in the case where the valve lift characteristic variable means is provided, there is a problem of the structure of the exhaust-side valve-operating device becoming very complicated.

### SUMMARY OF THE INVENTION

The invention provides a control device for an internal combustion engine which is able to improve the characteristic of a turbosupercharger-equipped internal combustion engine, without complicating an exhaust-side valve-operating device.

A first aspect of the invention is an internal combustion engine control device including: an internal combustion engine in which a cylinder is provided with a turbo-side exhaust valve that opens and closes an exhaust port that communicates with a turbo-side exhaust passageway that leads to a turbine inlet opening of a turbosupercharger, and with a bypass-side exhaust valve that opens and closes an exhaust port that communicates with a bypass-side exhaust passageway that bypasses the turbine; a bypass control valve provided on the bypass-side exhaust passageway; an exhaust-side valve-operating device that opens and closes the turbo-side exhaust valve and the bypass-side exhaust valve in accordance with cam profiles that are provided, only one for each of the turbo-side exhaust valve and the bypass-side exhaust valve; and a control portion that controls degree of opening of the bypass control valve according to an operation status of the engine.

According to the first aspect, because each cylinder is provided with the turbo-side exhaust valve that opens and closes the exhaust port that communicates with the turbo-side exhaust passageway that leads to the turbine inlet opening of the turbosupercharger and the bypass-side exhaust valve that opens and closes the exhaust port that communicates with the bypass-side exhaust passageway that bypasses the turbine, it is possible to efficiently discharge the burned gas from the cylinders into the bypass-side exhaust passageway in a high-speed and high-load operation region, and therefore make the amount of residual gas very small. Therefore, the engine output in the high rotation speed region can be increased. Besides, because it becomes difficult for knocking to occur, the ignition timing retardation can be avoided or restrained, and better fuel economy can be obtained. Furthermore, in the first aspect, the exhaust-side valve-operating device has a simple construction in which the turbo-side exhaust valve and the bypass-side exhaust valve are opened and closed in accordance with the cam profiles that are provided for the two types of valves on an only-one-for-each basis. Therefore, the constraints in designing the cylinder head can be relaxed, and no deterioration of installability and less increase in cost or weight will be caused. Furthermore, by controlling the degree of opening of the bypass control valve according to the operation status of the engine, the amount of exhaust gas that flows into the bypass-side exhaust passageway can be appropriately controlled. Due to the features described above, it is possible to better various characteristics of the turbosupercharger-equipped internal combustion engine.

In the control device, the cam profiles may be designed so that the bypass-side exhaust valve opens before the turbo-side exhaust valve closes, and so that the bypass-side exhaust valve closes after the turbo-side exhaust valve closes.

Therefore, in a high-speed and high-load operation region, the burned gas in the cylinders can be discharged into the bypass-side exhaust passageway with heightened efficiency, so that the amount of residual gas can be made further less.

The internal combustion engine control device may further include: an exhaust valve pause mechanism that pauses the turbo-side exhaust valve in a closed state while allowing the bypass-side exhaust valve to be in operation; and a valve pause mechanism controller that causes the exhaust valve pause mechanism to pause the turbo-side exhaust valve in the closed state when the engine is started. The control portion may also open the bypass control valve if the turbo-side exhaust valve is paused.

According to this construction, at the time of startup of the engine, it is possible to pause the turbo-side exhaust valve in the closed state and open the bypass control valve. This allows the entire amount of exhaust gas of the internal combustion engine to flow into the bypass-side exhaust passageway. That is, the entire amount of exhaust gas can be caused to bypass the turbine and flow into the catalyst. Therefore, because the decline in exhaust gas temperature in the turbine can be avoided, high-temperature exhaust gas can be caused to flow into the catalyst, so that the catalyst can be quickly warmed up. As a result, emissions can be reduced.

In the control device, the turbosupercharger may be provided without a waste gate valve, and the control portion may control the degree of opening of the bypass control valve so that the bypass control valve performs a function as the waste gate valve.

According to this construction, because the bypass control valve can be caused to well perform a function as the waste gate valve, there is no need to provide a waste gate valve for the turbosupercharger, so that the structure of the turbosupercharger can be simplified.

Furthermore, in the control valve, the control portion may cause the bypass control valve to be in a fully closed state until an intercept point of the turbosupercharger is reached.

According to this construction, the bypass control valve can be kept in the fully closed state until an intercept point of the turbosupercharger is reached. This will cause the entire amount of exhaust gas of the internal combustion engine to flow into the turbine through the turbo-side exhaust passageway. Therefore, the rotation speed of the turbosupercharger can be rapidly raised, and the response delay of the charging pressure can be shortened.

Furthermore, in the control device, the control portion may cause the bypass control valve to be in a fully open state when the internal combustion engine is in a high-speed and high-load state.

According to this construction, the bypass control valve can be caused to be in the fully open state during the high-speed and high-load engine operation. This allows the burned gas in the cylinders to be efficiently discharged into the bypass-side exhaust passageway, and therefore makes the amount of residual gas very small. Therefore, the engine output can be increased in the high rotation speed region. Besides, because it becomes difficult for knocking to occur, the ignition timing retardation can be avoided or restrained, and better fuel economy can be obtained.

Furthermore, in the control device, when the engine is in a high-speed and high-load state, valve overlap between the turbo-side exhaust valve and the intake valve may become completely null or approximately zero, and the bypass-side exhaust valve and the intake valve may have a valve overlap.

According to this construction, during the high-speed and high-load engine operation, the valve overlap between the turbo-side exhaust valve and the intake valve can be eliminated or made approximately zero, and a valve overlap between the bypass-side exhaust valve and the intake valve can be caused to exist. Therefore, during the period of the valve overlap between the bypass-side exhaust valve and the intake valve, the burned gas in the cylinders can be swept out by fresh air flowing in via the intake valves, and can be efficiently discharged into the bypass-side exhaust passageway, which is low in back pressure. Besides, because there is almost no valve overlap between the turbo-side exhaust valve and the intake valve, it is possible to reliably prevent the reverse flow of exhaust gas from the turbo-side exhaust passageway, which is high in back pressure, into the cylinders or the intake ports. Therefore, the amount of gas remaining in the cylinders during the high-speed and high-load engine operation can be made further less, so that the engine output can be further increased, and the knock resistance can be further improved, and the fuel economy can be further bettered.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a diagram for describing a system construction of Embodiment 1 of the invention;

FIG. 2 is a diagram showing cam profiles of an intake valve and exhaust valves; and

FIG. 3 is a diagram showing the engine rotation speed and the shaft torque.

### DETAILED DESCRIPTION OF THE EMBODIMENTS

### Embodiment 1

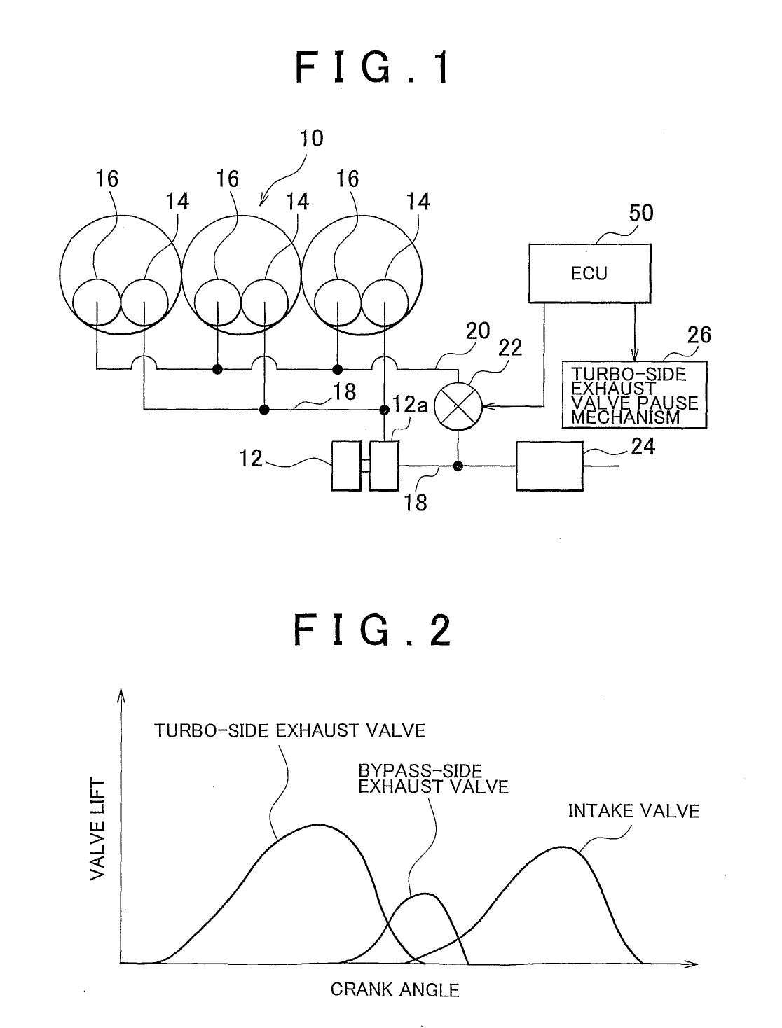

FIG. 1 is a diagram schematically showing a system construction of Embodiment 1 of the invention. As shown in FIG. 1, the system of this embodiment includes an internal combustion engine 10. In the invention, the number of cylinders of the internal combustion engine 10 and the cylinder arrangement thereof are not particularly limited. The internal combustion engine 10 of this embodiment has six cylinders in a V arrangement, and one of the two banks thereof is shown in FIG. 1.

The internal combustion engine 10 is equipped with a turbosupercharger 12. Each cylinder of the internal combustion engine 10 is provided with two exhaust valves, that is, a turbo-side exhaust valve 14 and a bypass-side exhaust valve 16. The exhaust port provided with the turbo-side exhaust valve 14 communicates with a turbo-side exhaust passageway 18 that leads to an inlet opening of a turbine 12a of the turbosupercharger 12. On the other hand, the exhaust port provided with the bypass-side exhaust valve 16 communicates with a bypass-side exhaust passageway 20 that does not lead to the inlet opening of the turbine 12a.

A bypass control valve 22 that opens and closes the bypass-side exhaust passageway 20 is installed in the bypass-side exhaust passageway 20. The turbo-side exhaust passageway 18 on the downstream side of the turbine 12a and the bypass-side exhaust passageway 20 on the downstream side of the bypass control valve 22 join into a single passageway. A catalyst 24 that purifies exhaust gas is installed in the downstream side of the joined portion between the two passageways.

The system of this embodiment includes an ECU (Electronic Control Unit) 50 that functions as a control device. Besides the bypass control valve 22, various components, although not shown in the drawings, are electrically connected to the ECU 50, including various actuators of a fuel injection device, an ignition device, a throttle valve, and various sensors such as a crank angle sensor, an air flow meter, a charging pressure sensor.

FIG. 2 is a diagram showing the cam profiles of an intake valve and exhaust valves of the internal combustion engine 10. As shown in FIG. 2, the bypass-side exhaust valve 16 is designed to open prior to the closing timing of the turbo-side exhaust valve 14 (i.e., to open during the latter half of the exhaust stroke), and close after the closing timing of the turbo-side exhaust valve 14 (i.e., to close after the top dead center). It is preferable that the angle of action and the amount of lift of the bypass-side exhaust valve 16 be substantially half the angle of action and substantially half the amount of lift of the turbo-side exhaust valve 14. Besides, the valve overlap of the turbo-side exhaust valve 14 and the intake valve which is an overlap between the open-valve periods of the valves is approximately zero. On the other hand, the bypass-side exhaust valve 16 and the intake valve have a valve overlap between their open periods.

In an exhaust-side valve-operating device of the internal combustion engine 10, each of the turbo-side exhaust valves 14 and the bypass-side exhaust valves 16 is provided with only one cam profile (valve lift curve) as shown in FIG. 2. That is, the exhaust-side valve-operating device of the internal combustion engine 10 is not equipped with a cam profile switching mechanism that switches the cam profile of each of the turbo-side exhaust valves 14 and the bypass-side exhaust valves 16 between a low-speed profile and a high-speed profile, nor with a valve lift variable mechanism capable of continuously varying the amounts of lift of the turbo-side exhaust valves 14 and the bypass-side exhaust valves 16, or the like. Therefore, the exhaust-side valve-operating device of the internal combustion engine 10 can be very simply constructed.

However, in this embodiment, the exhaust-side valve-operating device of the internal combustion engine 10 is equipped with a turbo-side exhaust valve pause mechanism 26 that pauses only the turbo-side exhaust valves 14 in the closed state while allowing the bypass-side exhaust valves 16 to be in operation. Since the structure of the turbo-side exhaust valve pause mechanism 26 is known to public, the detailed description thereof is omitted. Briefly, the turbo-side exhaust valve pause mechanism 26 is much simpler in construction than the cam profile switching mechanism and the valve lift variable mechanism mentioned above. Hence, the provision of the turbo-side exhaust valve pause mechanism 26 does not complicate the exhaust-side valve-operating device of the internal combustion engine 10. Incidentally, the action of the turbo-side exhaust valve pause mechanism 26 is controlled by the ECU 50.

The ECU 50 controls the degree of opening of the bypass control valve 22 and the action of the turbo-side exhaust valve pause mechanism 26 according to the operation status of the internal combustion engine 10.

(1) At Time of Engine Startup

At the time of engine startup, the ECU 50 fully opens the bypass control valve 22, and causes the turbo-side exhaust valve pause mechanism 26 to pause the turbo-side exhaust valves 14 in the closed state. This will cause the entire amount of exhaust gas of the internal combustion engine 10 to flow into the bypass-side exhaust passageway 20. Specifically, the entire exhaust gas bypasses the turbine 12a, and flows into the catalyst 24. Therefore, because the decline in exhaust gas temperature in the turbine 12a is avoided, high-temperature exhaust gas is caused to flow into the catalyst 24, so that the catalyst 24 can be warmed up quickly. As a result, emissions can be reduced.

When the catalyst warm-up is completed, the ECU 50 switches the state of the turbo-side exhaust valve pause mechanism 26 so that the turbo-side exhaust valve 14 operates in an ordinary manner.

(2) During Period Until Charging Pressure Reaches Intercept Point

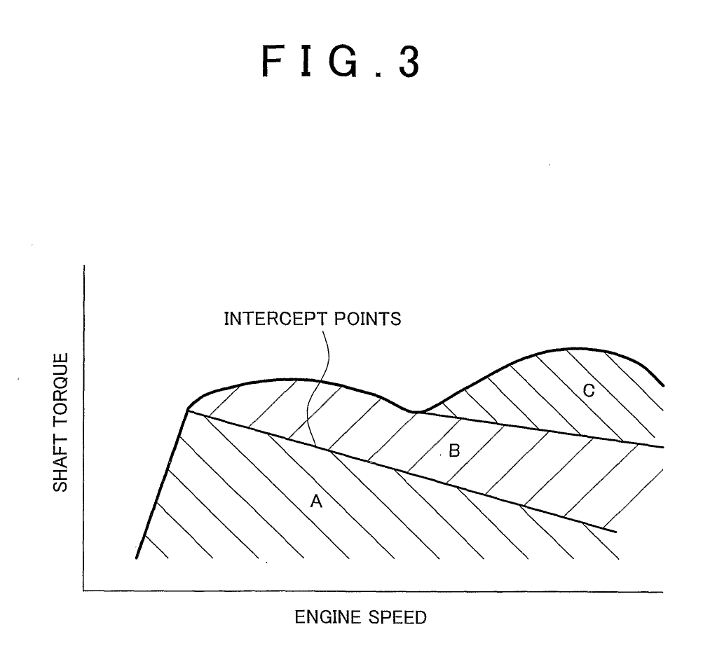

FIG. 3 is a diagram showing the engine rotation speed and the shaft torque of the internal combustion engine 10. As shown in FIG. 3, the operation region of the internal combustion engine 10 of this embodiment is divided into three regions A, B and C. The border line between the region A and the region B is a line obtained by connecting intercept points. An intercepting point is a point at which the charging pressure reaches a predetermined set charging pressure. The ECU 50 keeps the bypass control valve 22 in the fully closed state during the period until an intercept point is reached. Specifically, in the region A in FIG. 3, the ECU 50 causes the bypass control valve 22 to be in the fully closed state. This will cause the entire amount of exhaust gas of the internal combustion engine 10 to flow into the turbine 12a through the turbo-side exhaust passageway 18. Therefore, the rotation speed of the turbosupercharger 12 can be rapidly raised, and the response delay of the charging pressure can be shortened.

(3) After Charging Pressure Reaches Intercept Point

While the internal combustion engine 10 is in the region B in FIG. 3 after an intercept point has been reached, the ECU 50 controls the degree of opening of the bypass control valve 22 so that the charging pressure detected by the charging pressure sensor becomes equal to a set charging pressure (target charging pressure). This operation causes the bypass control valve 22 to well perform the function as a waste gate valve. Therefore, in this embodiment, there is no need to provide a waste gate valve for the turbosupercharger 12, so that the structure of the turbosupercharger 12 can be simplified.

(4) At Time of High Speed and High Load

ECU 50 keeps the bypass control valve 22 fully open when the internal combustion engine 10 is in a high-speed and high-load region near a maximum output point (the region C in FIG. 3). During this state, the gas remaining in the cylinders can be reduced to a very small amount for the following reasons. Firstly, because the bypass-side exhaust passageway 20 does not lead to the inlet opening of the turbine 12a, the back pressure is low. Therefore, the burned gas in the cylinders is easily discharged via the bypass-side exhaust valves 16. Furthermore, because the bypass-side exhaust valves 16 and the intake valves have a valve overlap, the burned gas in the cylinders can be swept out by fresh air flowing in via the intake valves, and therefore can be efficiently discharged into the bypass-side exhaust passageway 20. Besides, because the turbo-side exhaust valves 14 and the intake valves have almost no valve overlap, it is possible to reliably prevent the reverse flow of exhaust gas from the turbo-side exhaust passageway 18, which is high in back pressure, into the cylinders or the intake ports. Thus, because the amount of residual gas in the cylinders can be made very small as described above and the amount of air can be made correspondingly large, the output of the internal combustion engine 10 can be increased. Besides, because the amount of residual gas is small, knocking can be restrained, and the ignition timing retardation can be avoided. Therefore, increased engine output and better fuel economy can be achieved.

Although the control device for an internal combustion engine of the invention has been described above in terms of the embodiment shown in the drawings, the invention is not limited to the above-described embodiment. For example, the exhaust-side valve-operating device in an internal combustion engine in the invention may be equipped with a cam phase variable mechanism capable of varying the phase of a cam that drives an exhaust valve.

1. An internal combustion engine control device comprising:
an internal combustion engine in which a cylinder is provided with a turbo-side exhaust valve that opens and closes an exhaust port that communicates with a turbo-side exhaust passageway that leads to a turbine inlet opening of a turbosupercharger, and with a bypass-side exhaust valve that opens and closes an exhaust port that communicates with a bypass-side exhaust passageway that bypasses the turbine;
a bypass control valve provided on the bypass-side exhaust passageway;
an exhaust-side valve-operating device that opens and closes the turbo-side exhaust valve and the bypass-side exhaust valve in accordance with cam profiles that are provided, only one for each of the turbo-side exhaust valve and the bypass-side exhaust valve; and
a control portion that controls degree of opening of the bypass control valve according to an operation status of the internal combustion engine.

2. The internal combustion engine control device according to claim 1, characterized in that
the cam profiles are designed so that the bypass-side exhaust valve opens before the turbo-side exhaust valve closes, and so that the bypass-side exhaust valve closes after the turbo-side exhaust valve closes.

3. The internal combustion engine control device according to claim 1 or 2, further comprising:
an exhaust valve pause mechanism that pauses the turbo-side exhaust valve in a closed state while allowing the bypass-side exhaust valve to be in operation; and
a valve pause mechanism controller that causes the exhaust valve pause mechanism to pause the turbo-side exhaust valve in the closed state when the internal combustion engine is started,
wherein the control portion opens the bypass control valve if the turbo-side exhaust valve is paused.

4. The internal combustion engine control device according to any one of claims 1 to 3, characterized in that
the turbosupercharger is not provided with a waste gate valve, and
the control portion controls the degree of opening of the bypass control valve so that the bypass control valve performs a function as the waste gate valve.

5. The internal combustion engine control device according to any one of claims 1 to 4, characterized in that
the control portion controls the degree of opening of the bypass control valve in order to adjust charging pressure of the turbosupercharger.

6. The internal combustion engine control device according to any one of claims 1 to 5, characterized in that
the control portion causes the bypass control valve to be in a fully closed state until rotation speed of the internal combustion engine reaches an intercept point of the turbosupercharger.

7. The internal combustion engine control device according to any one of claim 6, characterized in that
the intercepting point is a point at which the charging pressure reaches a predetermined charging pressure.

8. The internal combustion engine control device according to any one of claims 1 to 7, characterized in that
the control portion causes the bypass control valve to be in a fully open state when the internal combustion engine is in a high-speed and high-load state.

9. The internal combustion engine control device according to any one of claims 1 to 8, characterized in that
when the internal combustion engine is in a high-speed and high-load state, valve overlap between the turbo-side exhaust valve and the intake valve is completely null or approximately zero, and the bypass-side exhaust valve and the intake valve have a valve overlap.
